(19) United States
(12) Patent Application Publication
(10) Pub. No.: US 2021/0320558 A1
(43) Pub. Date: Oct. 14, 2021

(54) A FREESTANDING SOUND ATTENUATING APPARATUS FOR KITCHEN APPLIANCES

(71) Applicant: Paul MCNAMARA, Northbridge (AU)

(72) Inventor: Paul MCNAMARA, Northbridge (AU)

(21) Appl. No.: 17/264,160

(22) PCT Filed: Aug. 14, 2019
(86) PCT No.: PCT/AU2019/050850

§ 371 Date: Jan. 28, 2021

(30) Foreign Application Priority Data
Aug. 14, 2018 (AU) 2018902971

(51) Int. Cl. H02K 5/24; A47J 43/07; G10K 11/162

(52) U.S. Cl. CPC H02K 5/24; G10K 2210/105; G10K 11/162; A47J 43/07

(57) ABSTRACT

A freestanding sound attenuating apparatus for a kitchen appliance has a rigid plastic dome defining an interior having an inner surface area and having a coplanar rim surrounding an inferior opening. The dome can therefore stand on a substantially planar surface with the kitchen appliance inserted via the inferior opening to be contained within the interior. The dome has a transparent window and sound absorbing material partially lining the inner surface area of the dome and which avoids the window. The sound absorbing material may line between 20-75% of the interior surface of the dome whilst conferring substantial sound attenuation properties evident from measurements contained herein.

### FIELD OF THE INVENTION

This invention relates generally to sound reducing devices for kitchen appliances.

### BACKGROUND OF THE INVENTION

Sound reducing devices for kitchen appliances of various configurations exist including US 2003/0042069 A1 (EILERS) 6 Mar. 2003 [hereinafter referred to as D1] which discloses a flexible material muffling hood of cylindrical cross-section which is for placing atop a coffee grinder.

D1 however was found to be deficient in having to remove the material cover to view and/or operate certain devices therein. Furthermore, the hood material may require a reinforcement stiffening element to properly form the hood, being difficult to manufacture. Furthermore, the flexible material hood is not well-suited for standing erect and rigid around tall appliances, such as “bullet-style” personal blenders. Furthermore, flexible material has deficient sound attenuating properties as compared to solid walled enclosures.

U.S. Pat. No. 4,883,144 A (HAUSHALTER et al.) 28 Nov. 1989 [hereinafter referred to as D2] discloses a sound absorbing box for an appliance having a door which, when closed, provides power to the appliance.

The hinged door opening of D2 is a more complex arrangement as compared to D1, thereby being more difficult to produce and not as robust as the configuration of D1. Furthermore, D2 may pose inconvenience for inserting and accessing kitchen appliances therein, especially tall appliances.

U.S. Pat. No. 6,019,238 A (KINDIG et al.) 1 Feb. 2000 [hereinafter referred to as D3] discloses a hinged lid assembly for blenders/food processors.

The pivoting hood arrangement of D3 is similarly a more complex arrangement as compared to D1 and sound escapes between the lid and the body which may necessitate installation of gaskets.

The present invention seeks to provide apparatus, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein a freestanding sound attenuating apparatus for a kitchen appliance.

The device comprises a rigid plastic dome defining an interior and having a coplanar rim surrounding an inferior opening. The dome is thereby configured for standing on a surface, such as a planar kitchen surface with a kitchen appliance inserted via the inferior opening to be contained within the interior thereof. The dome forms a partial air and sound lock with the surface and the blender is freestanding in that the blender does not physically contact the dome thereby avoiding direct mechanical vibration transmission therethrough. The dome may be made from lightweight and resilient polycarbonate, a durable and acoustically reflective material that acts as a noise barrier. The plastic dome may be made from a polymer nanocomposite with greater sound attenuation than that of the base polymer.

The present device is simpler to construct and has more robust configuration as opposed to the arrangements of D2 and D3 for example. Furthermore, the present device may be easily dropped over and lifted from an appliance via the inferior opening as compared to the opening of doors and hinged lids of the arrangements D2 and D3.

The front of the dome is transparent, thereby defining a viewing window at least partially therethrough for viewing the kitchen appliance in use. In a preferred embodiment, the entire dome is integrally formed of rigid plastic such as one manufactured from an injection moulding process.

Furthermore, the device comprises sound absorbing material lining inner surfaces of the dome. The sound absorbing material is strategically positioned to absorb high pitch frequencies from the motor of the electric appliance and blending action of the blades, while still permitting a view of the electric appliance.

We found unexpectedly that lining the internal surface of the dome with sound absorbing material only partially lining the internal surface of the dome (such as by as little as 25% coverage) may be sufficient for providing substantial sound attenuating performance without the disadvantages of having to line the entire interior of the dome or of D1 of not being able to view the kitchen appliance therein during use.

For example, with reference to FIG. 8, for an electric blender producing 85 dBA without enclosure (85 dBA—measurement 101), the present dome without sound absorbing material therein attenuates the sound by 10 dBA (75 dBA—measurement 102).

Furthermore, with the entire interior of the dome being lined with sound absorbing material (such as open cell polyurethane), we found that there was a further reduction of 9 dBA (66 dBA—measurement 103).

However, lining only 65% of the interior of the enclosure was found unexpectedly to only retard the sound attenuation by 1 dBA (67 dBA—measurement 104). Even further, lining only 25% of the interior was unexpectedly found to only retard the sound attenuation by a yet further 2 dBA (69 dBA—measurement 105).

As such, we found that lining between 20-75% of an inner surface of the dome provides reasonable sound attenuating properties without having to line the entire interior of the dome and whilst allowing a front transparent window of the dome to remain unobscured.

As such, in accordance with a preferred embodiment, we devised a freestanding sound attenuating apparatus for a kitchen appliance which has a rigid plastic dome defining an interior having an inner surface area and having a coplanar rim surrounding an inferior opening, the dome thereby configured in use for standing on a planar surface with the kitchen appliance inserted via the inferior opening to be contained within the interior.

Furthermore, the dome defines a transparent window (preferably through a front face of the dome).

Furthermore, the apparatus further comprises sound absorbing material which only partially lines the inner surface area of the dome and avoids the window.

The sound absorbing material may line between 20-75% of the interior surface of the dome whilst conferring the sound attenuation properties evident from measurements 104 and 105 of FIG. 8. In one embodiment, the sound absorbing material may line the side and rear inner surfaces of the dome as illustrated in FIG. 2, thereby lining only approximately 65% of the interior surface of the dome whilst providing the sound attenuating properties of measurement 104 of FIG. 8.

In a further particular configuration, the top of the dome may be configured to define a recessed channel in from edges of the top, thereby defining an interior channel within the dome which receives a correspondingly shaped upper edge of the sound absorbing material therein.

The interior channel may be U-shaped and the upper edge of the sound absorbing material may be correspondingly U-shaped. The sound absorbing material may be made from a single piece of material which is bent into this shape at two vertical corners. Furthermore, the width of the interior channel may be slightly less than the thickness of the sound absorbing material such that the sound absorbing material can be wedged into the interior channel.

The interior channel may shape the upper edge of the sound absorbing material such that the top of the sound absorbing material is held outwardly against interior surfaces of the sides and rear of the dome.

The U-shaped cross-section may have a front and sides which meet at an angle of less than 90° (such as approximately 88°) thereby allowing the front edges of the slightly oversized sound absorbing material to wedge outwardly against the acute angle between the front and side walls in compression. This compression further may also result in an outwards acting force which pushes the sides and rear of the foam against the sides and rear of the dome.

Furthermore, the dome may comprise a cross-section that widens towards the rim and the sound absorbing material may widen towards a bottom edge thereof such that the front edges of the sound absorbing material wedge against inner surfaces of the front of the dome.

With this particular configuration, the sound absorbing material is held appropriately in place and avoids obscuring the front transparent window through the front of the dome.

Furthermore, this particular configuration allows the sound absorbing material to be held in place without adhesive or fasteners. As such, the sound absorbing material can be easily inserted during manufacture and use and may be easily removed and replaced for periodic washing of the dome.

As such, in light of the prior art sound reducing enclosures, the present invention is of a simple configuration which confers advantages of interior viewability without substantially retarding the sound attenuating properties thereof. Preferred embodiments of the present invention allow for the accommodation of sound absorbing material within an interior of the enclosure which avoids adhesive, shapes the sound absorbing material properly and allows for easy periodic removal and replacement of the sound absorbing material.

According to one aspect, there is provided a freestanding sound attenuating apparatus for a kitchen appliance, the device comprising a rigid plastic dome defining an interior having an inner surface area and having a coplanar rim surrounding an inferior opening, the dome thereby configured in use for standing on a substantially planar surface with the kitchen appliance inserted via the inferior opening to be contained within the interior, wherein the dome defines a transparent window and wherein the apparatus further comprises sound absorbing material and wherein the sound absorbing material only partially lines the inner surface area of the dome and wherein the sound absorbing material avoids the window.

The sound absorbing material may line between 20-75% of the inner surface of the dome.

The dome may further define sides and a rear and wherein the sound absorbing material may have a height and the sound absorbing material defines side portions and a rear portion such that when the sound absorbing material may be inserted within the dome, the height of the sound absorbing material may be accommodated within the dome and wherein the side portions of the sound absorbing material line inner surfaces of the sides of the dome and wherein the rear portion of the sound absorbing material lines an inner rear surface of the rear of the dome.

The sound absorbing material may line between 50-75% of the interior surface of the dome.

The sides and rear of the dome may define a U-shaped cross-section and wherein the sound absorbing material may be of a single piece of material bent to conform to the inner surface of the side and rear U-shaped cross-section.

The dome may further define a planar front and wherein each respective side approaches the planar front at an acute angle such that the inner face of the sound absorbing material meets the planar front at an angle of less than 90°.

A top of the dome may be shaped to define a peripheral channel portion defining an interior channel and wherein an upper edge of the sound absorbing material fits within the interior channel.

The interior channel may be U-shaped and wherein an upper edge of the sound absorbing material may be correspondingly U-shaped.

The interior channel may have a width less than that of an uncompressed thickness of the sound absorbing material such that the upper edge of the sound absorbing material wedges within the interior channel.

The peripheral channel portion may be formed by a recessed channel in from edges of the top.

The recessed channel may define a central boss.

The dome may have a cross-section widening towards the rim and wherein the sound absorbing material widens towards a lower edge thereof such that when the upper edge thereof meets the top of the dome, front edges of the sound absorbing material contact against respective lateral inner surfaces of the front.

The dome may be of unitary construction.

The dome may be entirely transparent.

The dome may comprise polycarbonate.

The sound absorbing material may comprise open cell polyurethane.

The rim may rise to form a cable relief.

An undersurface of the coplanar rim may be planar and may have a width of greater than 5 mm.

The apparatus may further comprise a button operating protrusion extending in from an interior surface of the front wall.

The protrusion may be adhered to the interior surface of the front wall by a suction cup.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a front perspective view of a freestanding sound attenuating apparatus enclosing a kitchen appliance therein;

FIG. 2 shows an exploded perspective view of the apparatus in accordance with an embodiment;

FIG. 3 shows a top view of the enclosure;

FIG. 4 shows a front elevation cross-sectional view of the enclosure;

FIG. 5 shows a side elevation cross-sectional view of the enclosure;

FIG. 6 shows a magnified view of the rim of the enclosure in accordance with an embodiment;

FIG. 7 shows a cable relief of the rim of the enclosure in accordance with an embodiment; and

FIG. 8 shows experimental results showing dB attenuation verse sound absorbing material interior surface coverage.

### DESCRIPTION OF EMBODIMENTS

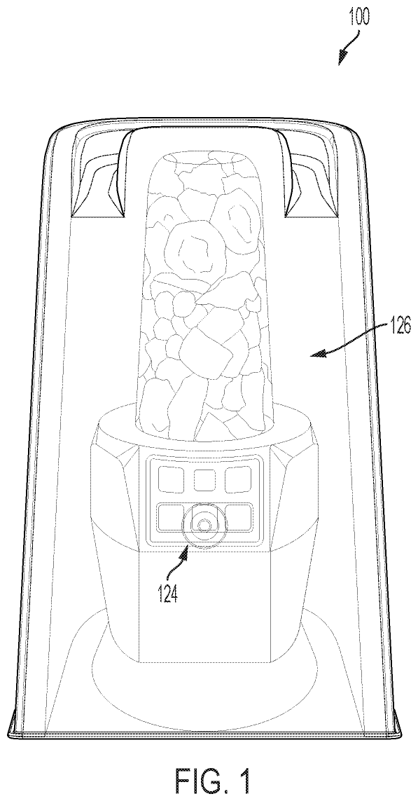

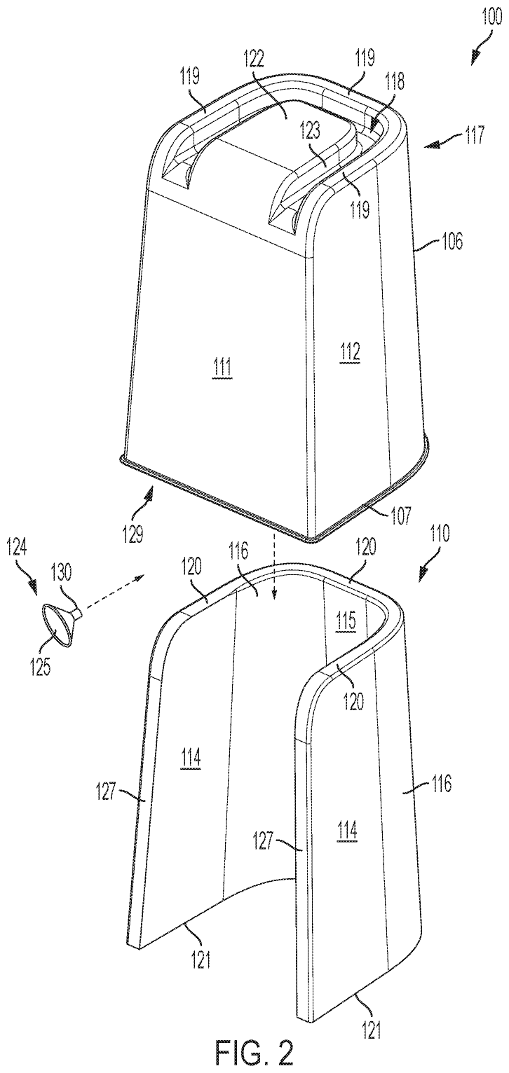

Sound attenuating apparatus 100 comprises a rigid plastic dome 106 defining an interior for a kitchen appliance 126, such as a “bullet-style” personal blender in the embodiment shown in FIG. 1. The dome 106 comprises a rim 107 defining an inferior opening 129. With reference to FIGS. 4 and 5, the rim 107 is coplanar for standing on a planar surface, such as a kitchen countertop. The coplanar rim 107 substantially seals the inferior opening of the dome 106 against a substantially planar surface (such as a kitchen countertop surface), thereby containing the kitchen appliance therein in a substantially airtight manner, thereby reducing direct transmission of sound through the air.

With reference to FIG. 7, in embodiments, the rim 107 may rise to form a cable relief 108 for accommodating an electrical cable of the kitchen appliance 126 therethrough. Preferably the relief 108 is relatively narrow, such as by comprising a width of less than 20 mm, thereby reducing sound escaping therethrough in use. The cable relief 108 may comprise a height of more than 5 mm but less than 10 mm such as approximately 7 mm as shown.

When placed atop a planar surface, the rim 107 may lie flush against the planar surface, except at the cable relief 108. The cable relief 108 may locate at a rear of the dome 106.

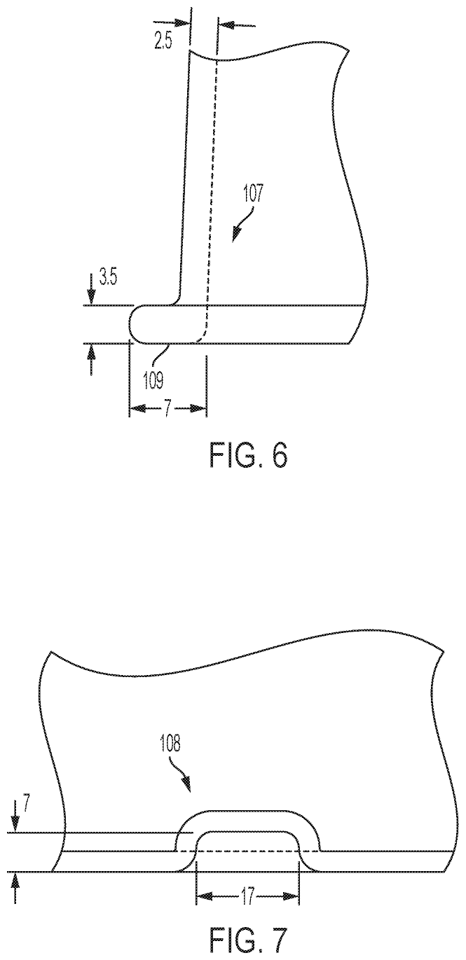

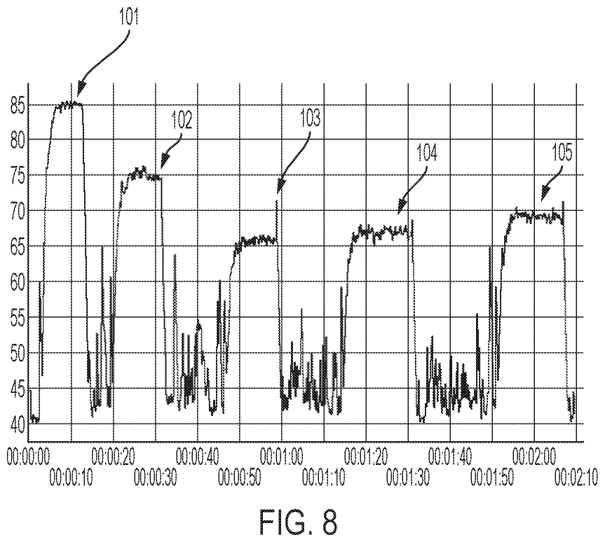

With reference to FIG. 6, the rim 107 may extend to define a planar undersurface 109 for enhancing sound attenuation. The undersurface 109 preferably has a width of greater than 5 mm, such as approximately 7 mm as shown.

The apparatus 100 comprises sound absorbing material 110. The sound absorbing material 110 lines an interior of the dome 106, thereby absorbing sound waves within the interior. The sound absorbing material 110 may comprise open cell polyurethane. The sound absorbing material may comprise a thickness of 20 mm.

The sound absorbing material 110 may be configured to line between 20-75% of an interior surface area of the dome 106.

At least a front 111 of the dome 106 is at least partially or entirely transparent, thereby defining a full or at least partial viewing window therethrough. The entire dome 106 may be transparent in embodiments and, for example, may be made from transparent polycarbonate made via an injection moulding process.

The sound absorbing material 110 may be shaped and configured to avoid the front 111 entirely (or at least partially) so as to yet allow viewing through the front window.

The dome 106 further defines sides 112 and a rear 113. The sound absorbing material 110 may comprise side portions 114 and a rear portion 115 therebetween. The sound absorbing material 110 may be formed from a single sheet of sound absorbing material which is bent at two vertical corners 116 to form the portions 114, 115.

As such, when the sound absorbing material 110 is inserted within the dome 106, the height of the sound absorbing material 110 is accommodated within the dome 106 and the side portions 114 lie against inner surfaces of the sides 112 of the dome 106 and the rear portion 115 lies against and inner surface of the rear 113 of the dome 106, thereby avoiding the front 111 of the dome 106 for viewing therethrough. The height of the sound absorbing material 110 preferably substantially entirely accommodates the interior height of the dome 106.

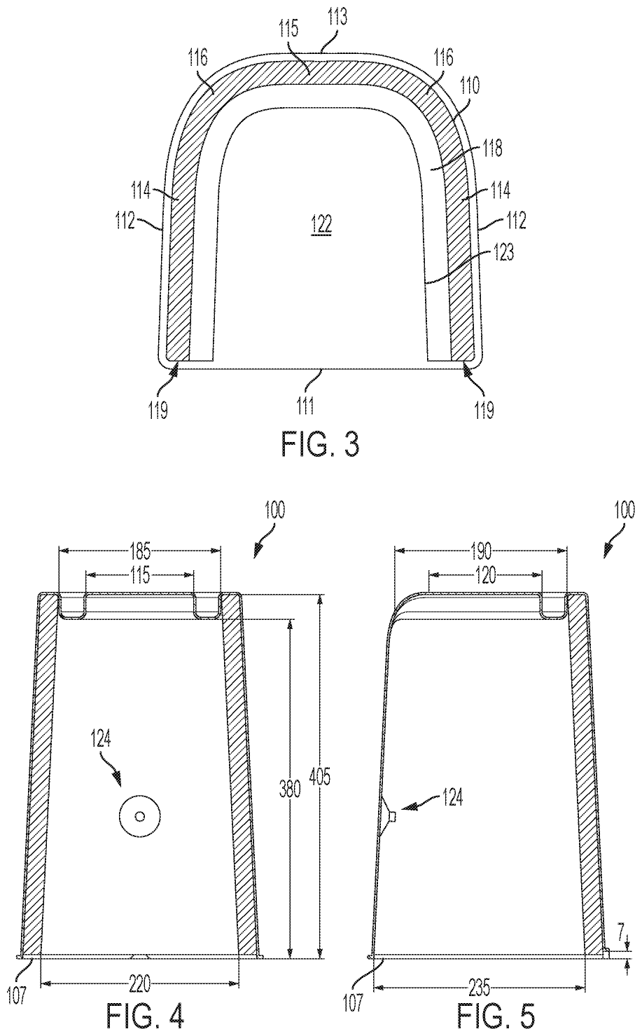

In a preferred embodiment, the front 111 of the dome 106 is planar with the sides 112 and rear 113 curving rearwardly therebetween. The sides 112 may also be planar and, furthermore, the rear 113 may also be planar as illustrated in FIG. 3, with the dome 106 curving between the planar sides 112 and the planar rear 113.

In embodiments, a top 117 of the dome 106 may define a central recess or a peripheral channel 118 recessed therein in from edges of the top 117 thereby defining a channelled portion 119 which defines a corresponding interior channel within the interior of the dome 106. The channel 118 may run along the sides and the rear such that the channelled portion 119 is substantially U-shaped.

Upper edges 120 of the sound absorbing material 110 may conform to a U-shape so as to be accommodated or wedged within the correspondingly shaped interior channel of the channelled portion 119, the upper edge of the sound absorbing material 110 thereby being shaped to properly form the sound absorbing material 110 against inner surfaces of the dome 106.

As is evident from FIG. 3, the side walls 112 may meet the front wall 111 at an angle less than 90°, such as approximately 88° so that the front edges 127 of the sound absorbing material 110 are more firmly wedged in place by the acute angle between inner surfaces of the sides 112 and front 111 of the dome 111 whilst pressing the side portions 114 against inner surfaces of the side wall 112 and the rear portion 115 against inner surfaces of the rear wall 113

The dome 106 may widen towards the rim 107. In this embodiment of the sound absorbing material 110 may similarly widen from the top edge 120 and a bottom edge 121 thereof.

The channel 118 may define a central boss 122. The central boss 122 may allow a greater interior height for accommodation of taller appliances as is illustrated in FIG. 1.

A user's fingers may be inserted within the channel 118 and gripped oppositely against peripheries 123 of the boss 122 for purchase when lifting the dome 106. Alternatively, the dome may be gripped by placing a thumb in the channel 118 and squeezing against the remaining fingers placed on the side wall 112.

In embodiments, a suction knob 124 having a suction cap 125 may be provided to affix to an interior surface of the front 111 of the dome 106. The suction knob 124 defines a protrusion 130. As such, the suction cup 125 may be adhered at a particular location within the dome 106 in the manner illustrated in FIG. 1 to collocate with a button of the electrical appliance 126. Pressing against the front 111 of the dome 106 causes the front 111 to flex slightly, thereby pressing the protrusion 130 against the button to control the operation of the electrical appliance. The dome may be tilted backwards by gripping between the channel 118 and side wall 112 to temporally position the protrusion 130 against other buttons if need be.

FIGS. 4 and 5 show exemplary dimensions of the dome 106 which we found provided internal clearances especially suited for common types of commercially available blenders.

Specifically, at the bottom of the dome 106 with reference to FIG. 5, there may be clearance of approximately 235 mm from the sound absorbing material 110 and the front 111 of the dome 106. At the top of the dome 106, there may be clearance of approximately 190 mm between the sound absorbing material 110 and the front 111 of the dome 106.

With reference to FIG. 4, clearance of approximately 220 mm may be provided between inner surfaces of the sound absorbing material 110. At the top of the dome 106, clearance of approximately 185 mm may be provided between inner surface of the sound absorbing material 110.

Further with reference to FIG. 4, clearance of approximately 380 mm may be provided to the channel 118 and a further 25 mm (up to 405 mm) to an undersurface of the boss 122.

The term “approximately” or similar as used herein should be construed as being within 10% of the value stated unless otherwise indicated.

In embodiments, the interior yet has sufficient volume so as to not increase temperatures therein beyond certain thresholds during short periods of use such as operation of a blender for about one minute.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A freestanding sound attenuating apparatus for a kitchen appliance, the device comprising a rigid plastic dome defining an interior having an inner surface area and having a coplanar rim surrounding an inferior opening, the dome thereby configured in use for standing on a substantially planar surface with the kitchen appliance inserted via the inferior opening to be contained within the interior, wherein the dome defines a transparent window and wherein the apparatus further comprises sound absorbing material and wherein the sound absorbing material only partially lines the inner surface area of the dome and wherein the sound absorbing material avoids the window.

2. Apparatus as claimed in claim 1, wherein the sound absorbing material lines between 20-75% of the inner surface of the dome.

3. Apparatus as claimed in claim 1, wherein the dome further defines sides and a rear and wherein the sound absorbing material has a height and the sound absorbing material defines side portions and a rear portion such that when the sound absorbing material is inserted within the dome, the height of the sound absorbing material is accommodated within the dome and wherein the side portions of the sound absorbing material line inner surfaces of the sides of the dome and wherein the rear portion of the sound absorbing material lines an inner rear surface of the rear of the dome.

4. Apparatus as claimed in claim 3, wherein the sound absorbing material lines between 50-75% of the interior surface of the dome.

5. Apparatus as claimed in claim 3, wherein the sides and rear of the dome define a U-shaped cross-section and wherein the sound absorbing material is of a single piece of material bent to conform to the inner surface of the side and rear U-shaped cross-section.

6. Apparatus as claimed in claim 5, wherein the dome further defines a planar front and wherein each respective side approaches the planar front at an acute angle such that the inner face of the sound absorbing material meets the planar front at an angle of less than 90°.

7. Apparatus as claimed in claim 3, wherein a top of the dome is shaped to define a peripheral channel portion defining an interior channel and wherein an upper edge of the sound absorbing material fits within the interior channel.

8. Apparatus as claimed in claim 7, wherein the interior channel is U-shaped and wherein an upper edge of the sound absorbing material is correspondingly U-shaped.

9. Apparatus as claimed in claim 8, wherein the interior channel has a width less than that of an uncompressed thickness of the sound absorbing material such that the upper edge of the sound absorbing material wedges within the interior channel.

10. Apparatus as claimed in claim 7, wherein the peripheral channel portion is formed by a recessed channel in from edges of the top.

11. Apparatus as claimed in claim 10, wherein the recessed channel defines a central boss.

12. Apparatus as claimed in claim 7, wherein the dome has a cross-section widening towards the rim and wherein the sound absorbing material widens towards a lower edge thereof such that when the upper edge thereof meets the top of the dome, front edges of the sound absorbing material contact against respective lateral inner surfaces of the front.

13. Apparatus as claimed in claim 1, wherein the dome is of unitary construction.

14. Apparatus as claimed in claim 13, wherein the dome is entirely transparent.

15. Apparatus as claimed in claim 14, wherein the dome comprises polycarbonate.

16. Apparatus as claimed in claim 1, wherein the sound absorbing material comprises open cell polyurethane.

17. Apparatus as claimed in claim 1, wherein the rim rises to form a cable relief.

18. Apparatus as claimed in claim 1, wherein an undersurface of the coplanar rim is planar and has a width of greater than 5 mm.

19. Apparatus as claimed in claim 1, further comprising a button operating protrusion extending in from an interior surface of the front wall.

20. Apparatus as claimed in claim 19, wherein the protrusion is adhered to the interior surface of the front wall by a suction cup.
